(19) United States
(12) Patent Application Publication
(10) Pub. No.: US 2009/0055120 A1
(43) Pub. Date: Feb. 26, 2009

(54) CALIBRATION COEFFICIENTS FOR SENSOR BASED MEASUREMENTS

(76) Inventors: Paul Edward Vickery, Northamptonshire (GB); John Peter Beckley, Oxfordshire (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/262,793

(22) Filed: Oct. 31, 2008

(51) Int. Cl. G01D 18/00

(52) U.S. Cl. 702/104

(57) ABSTRACT

A method, system and device for providing device specific calibration data for a sensor. A sensor device includes a transmitter, receiver, memory and a response portion responsive to a selected condition of the region. Generic calibration data associated with a group of sensors into which the sensor device falls is then stored in a database remote from the sensor device. Correction data for use in modifying the generic calibration data to more accurately fit the actuation calibration data of the sensor device is stored in the memory portion of the sensor device. The sensor device is interrogated with an interrogator device to obtain the correction data, and the generic calibration data relating to the sensor device is retrieved from the database and modified using the correction data to produce sensor device specific calibration data.

### BACKGROUND OF THE INVENTION

1. Field of the Invention

The present invention relates to systems and methods for associating calibration information with sensor devices.

2. The Prior Art

For certain types of sensor such as SAW tire pressure sensors it is necessary to provide individual calibration data for every sensor manufactured. When the sensor is measured/interrogated frequency information is obtained and using the calibration data and pre-defined algorithm temperature and pressure information can be derived.

Currently there are several methods for handling this data and the procedure for its use. WO2007/005020 discloses a system in which all calibration data is stored on an RFID tag that is kept with the sensor. Prior to interrogating the sensor, the tag is first read to retrieve the calibration coefficients. This system has the drawback, however, that it can take a significant amount of time to read all the required data. When a RFID tag is placed within an environment such as the wheel of a passenger car the read range can be severely effected. Particularly when the vehicle is moving at speed it can become difficult to have a long enough opportunity to read all the required data from the tag.

Another method is to group the sensors so that for a particular application only sensors that fall within a given range will be used and then an ‘average’ set of calibration coefficients could be used. A problem of this approach is that for some applications that require a high accuracy specification the groups can become very narrow thus making it logistically problematic with a large number of groups or suffer a very poor sensor yield.

A third approach, disclosed in EP1659374, is to provide again a RFID with the sensor but storing therein only a serial number/identification number which uniquely identifies the sensor with which it is associated. All applicable sensor coefficients are then stored in a database which may be stored locally to the interrogation electronics or may be stored remotely, being accessed from another onboard system or from an even remoter source such as via the internet. In use, the serial/identification number of the sensor is read and used to look up the calibration information in the database. A problem with this approach, however, is the size of the database and achieving access to it.

### SUMMARY OF THE INVENTION

These and other related objects are achieved by an embodiment of the invention which allows sensors to be quickly and accurately calibrated.

It is an object of the present invention to provide a remote database with gross calibration data for a group of sensors.

It is a further object to provide the sensor with fine calibration data to correct the gross calibration data.

According to the present invention there is provided a method of providing device specific calibration data for a sensor device, comprising the steps of placing a sensor device in a region whose environment is to be monitored, the sensor device having a transmitter portion, a memory portion and at least a portion which is responsive to a selected condition of the region; storing generic calibration data associated with a group of sensors into which the sensor device falls in a database remote from the sensor device; storing in the memory portion of the sensor device at least correction data for use in modifying the generic calibration data to more accurately fit the actuation calibration data of the sensor device; interrogating the sensor device with an interrogator device to obtain the correction data; retrieving the generic calibration data relating to the sensor device from the database; and modifying the generic calibration data using the correction data to produce sensor device specific calibration data.

The present invention further provides a sensor device comprising a portion which is response to a selected environmental variable of a region to be monitored, a transmitter portion and a memory portion, the memory portion storing at least correction data for modifying generic calibration data relating to a group of sensors into which the sensor device falls to produce sensor specific calibration data.

### BRIEF DESCRIPTION OF THE DRAWING

The advantages, nature, and various additional features of the invention will appear more fully upon consideration of the illustrative embodiments now to be described in detail in connection with accompanying drawing:

FIG. 1 is a schematic diagram of a sensor device according to an embodiment of the present invention.

### DETAILED DESCRIPTION OF THE PREFERRED EMBODIMENT

A method and sensor device in accordance with the invention has the advantage that it enables accurate calibration data for a sensor to be used in a manner which requires much less data to be stored both locally on the sensor and also in a database accessible by an interrogator than the prior art systems. This reduces the time required for extracting data from the sensor device and also enables the database to be stored more locally to the interrogator, avoiding the access problems associated with the prior art. More particularly, since the generic calibration data is calculated for the, or each, group and then each sensor is assigned to a group based on its actual calibration data, the data for the group or groups does not change when new sensors are manufactured, and hence does not have the same requirements for constant updating as in the prior art. Accordingly, the calibration coefficients for a particular class of sensor may be hard encoded into an interrogator, making look-up thereby particularly simple and quick.

The number of groups used to classify the sensor devices dependents on the accuracy required for the particular sensor application. In some embodiments, it may be acceptable to provide just a single set of generic calibration data which applies for all sensor devices, in which case no separate sensor identification system is required.

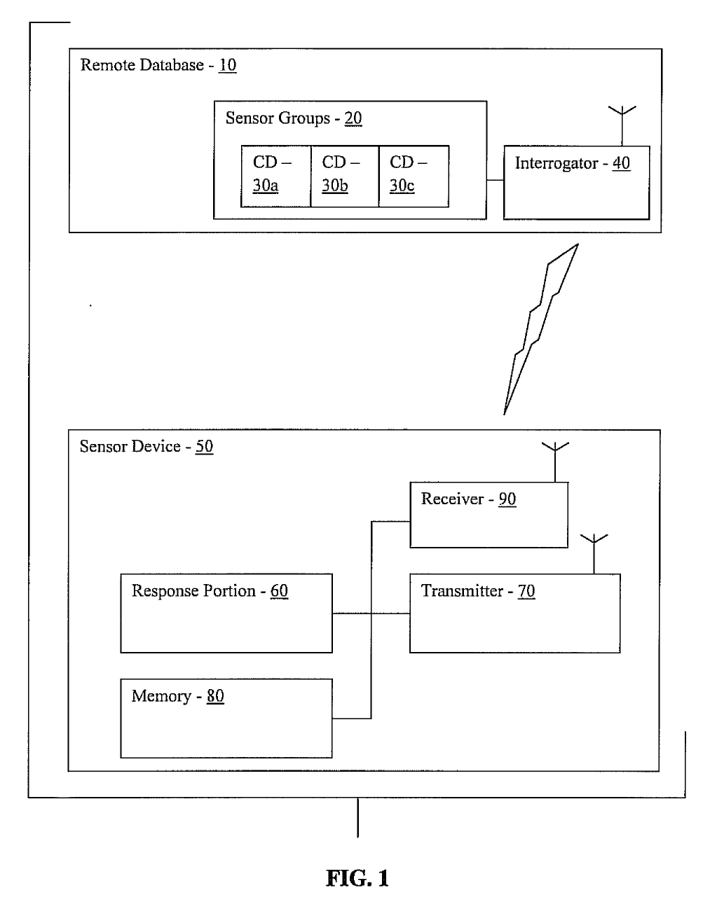

Features of the method, system and apparatus according to an embodiment of the invention are shown in FIG. 1. A sensor device 50 includes a response portion 60, a transmitter 70 and a memory portion 80. Response portion 60 may be a SAW sensor. Memory 80 stores correction data or identification data, in one or two memory portions. A receiver 90 is also provided. A remote database 10 includes sensor groups 20. Each group contains generic calibration data for that group, denoted as CD 30a, CD 30b, and CD 30c. An interrogator 40 is present to interrogate the sensor device 50. When interrogated, memory 80 provides correction data to correct the generic calibration data for the respective, or mapped, group, for example, CD 30b. Memory 80 may also provide identification data indicative of the sensor group to which it belongs.

In a preferred embodiment, however, a plurality of sensor groups are defined, generic calibration data for each group being defined, and each sensor device being classified into a particular group based on the deviation of its actual calibration data from the generic calibration data from the groups, correction data then being calculated based on the difference between the generic calibration data for the group into which the sensor is classified and the actual calibration data for the sensor. Identification means may also be provided on the sensor by means of which the group into which the sensor device has been classified may be read by the interrogator.

To that end, the method of the invention includes the farther steps of storing in a database remote from the sensor device calibration data relating to a plurality of sensor device groups, storing in the memory portion of the sensor device sensor identification data indicative of the sensor group into which the sensor device has been classified, interrogating the sensor device to obtain the identification data, using the identification system to identify the sensor group of the sensor device and retrieving the group specific generic calibration data from the database for the sensor device.

The present invention still further provides a method of monitoring at least one condition in an environment, comprising the steps of: providing a sensor for producing an output signal responsive to the at least one condition; locating said sensor in said environment; associating a memory device with the sensor; deriving correction data unique to the sensor for mapping generic calibration data associated with the sensor to fit the specific calibration data of the sensor; storing said correction data in the memory device; reading the correction data using an interrogation device; using the interrogation device to modify the generic calibration data; and using the modified calibration data to process the output signal of the sensor in order to obtain a reading of said condition in the environment.

Preferably, the method further comprises classifying the sensor into a sensor group having associated generic calibration data based on the actual calibration data of the sensor; storing in a database remote from the sensor generic calibration data for each sensor group; storing in the memory device sensor identification data identifying the sensor group into which the sensor has been classified; reading the sensor identification data using the interrogation device; and reading from the database the generic calibration data for the sensor group into which the sensor has been classified.

The present invention opens up markets which otherwise were impractical with prior art approaches. It also allows the system designer an additional flexibility when making trade-offs between system read time, system accuracy and system implementation logistics. Such a system would also allow the flexibility to use or not to use the correction factor, so that a system that could not afford the time could either read only some or none of the correction factors. Alternatively, if accuracy requirements were such then the correction factors could be left unused. These changes to the system could all be made through the software without any other reconfiguration.

In order that the invention may be well understood, there will now be described an embodiment thereof, given by way of example.

A system in accordance with the invention comprises a sensor such as a SAW tire pressure and temperature sensor. The sensor has associated with it an identification system such as an RFID tag which stores an electronic indicator which identifies a group into which the particular sensor falls. All the sensors in a particular group share common generic or ‘average’ set of calibration coefficients, that is the particular calibration coefficients for each sensor fall within a predetermined range of the generic values defined for the particular group. The number of groups will depend on the accuracy required for any particular application and may be a few as one group, in which case no identification system is required.

A database is established which records the generic calibration coefficients for each of the groups. This database is stored for access by the system during operation, and may be remotely located and accessible over a network such as the internet. However, the generic calibration coefficients for the groups represents much less data than the prior art system of storing individual calibration coefficients for all sensors in a database, and hence can advantageously be stored locally to an interrogator, and in particular can be hard encoded therein. Furthermore, since each new sensor which is produced will be classified into an existing group, the database will be fixed and will not, therefore need to be updated as with the prior art system.

Each sensor also has a set of correction factors associated with it, which are particular to the individual sensor and are used to adjust the generic calibration coefficients for the group into which the sensor has been placed to more accurately fit the actual calibration coefficients of the particular sensor. These correction factors again represent a much smaller amount of data than the actual calibration coefficients and therefore require much less storage space and more importantly much less time to be read by the interrogator in use. In the preferred embodiment, the correction data will be stored with the electronic indicator in the identification system.

In use, a sensor is installed in its operating location, such as in a tire, and an interrogator is located within scanning range of the sensor, for example proximate the wheel arch of a vehicle. The interrogator reads the RFID to download the electronic identifier (if one is present) as well as the correction factors for the sensor. The electronic identifier will, for example, simply be a group number and is used by the interrogator to identify the generic calibration coefficients which apply to the particular sensor. The interrogator then looks up the generic calibration coefficients relating to the particular sensor using the electronic identifier and then applies the correction factors, also read from the RFID, using a predefined correction function in order to calculate sensor specific calibration coefficients.

Operating data is also read directly from the sensor. In the preferred embodiment, this operating data is the resonant frequency of the SAW devices which make up the sensor, and the sensor specific coefficients are then used by the interrogation software in conjunction with the operating data and using pre-defined algorithms to derive the measured environmental information from the sensor, for example the temperature and pressure within the tire.

What is claimed is:

1. A method of providing device specific calibration data for a sensor device, comprising the steps of:
placing a sensor device in a region whose environment is to be monitored, the sensor device having a transmitter portion, a memory portion and a portion which is responsive to a selected condition of the region;
storing generic calibration data associated with a group of sensors into which the sensor device falls in a database remote from the sensor device;
storing in the memory portion of the sensor device at least correction data for use in modifying the generic calibration data to more accurately fit the actual calibration data of the sensor device;
interrogating the sensor device with an interrogator device to obtain the correction data;
retrieving the generic calibration data relating to the sensor device from the database; and
modifying the generic calibration data using the correction data to produce sensor device specific calibration data.

2. A method according to claim 1, comprising the further steps of:
storing in a database remote from the sensor device calibration data relating to a plurality of sensor device groups;
storing in a memory portion of the sensor device sensor identification data indicative of the sensor group into which the sensor device has been classified;
interrogating the sensor device to obtain the identification data;
using the identification system to identify the sensor group of the sensor device; and
retrieving the group specific generic calibration data from the database for the sensor device.

3. A method according to claim 2, wherein the identification data and the modification data are stored in the same memory portion.

4. A method according to claim 1, wherein the sensor device is a SAW based sensor device.

5. A method according to claim 1, wherein the database is stored locally to an interrogator for interrogating the sensor device.

6. A method according to claim 5, wherein the database is stored in the interrogator.

7. A method of monitoring at least one condition in an environment, comprising the steps of:
providing a sensor for producing an output signal responsive to the at least one condition;
locating said sensor in said environment;
associating a memory device with the sensor;
deriving correction data unique to the sensor for mapping generic calibration data associated with the sensor to fit the specific calibration data of the sensor;
storing said correction data in the memory device;
reading the correction data using an interrogation device;
using the interrogation device to modify the generic calibration data; and
using the modified calibration data to process the output signal of the sensor in order to obtain a reading of said condition in the environment.

8. A method according to claim 7, comprising the further steps of:
classifying the sensor into a sensor group having associated generic calibration data based on the actual calibration data of the sensor;
storing in a database remote from the sensor generic calibration data for each sensor group;
storing in the memory device sensor identification data identifying the sensor group into which the sensor has been classified;
reading the sensor identification data using the interrogation device; and
reading from the database the generic calibration data for the sensor group into which the sensor has been classified.

9. A sensor device comprising:
a portion which is response to a selected environmental variable of a region to be monitored;
a transmitter portion; and
a memory portion, the memory portion storing at least correction data for modifying generic calibration data relating to a group of sensors into which the sensor device falls to produce sensor specific calibration data.

10. A sensor device according to claim 9, further including a memory portion storing sensor identification data indicative of a group into which the sensor device has been classified

11. A sensor device according to claim 10, wherein a single memory portion is provided which stores both the correction data and the sensor identification data.

12. A sensor device according to claim 9, further including a receiver portion for receiving an interrogation signal from an interrogator.
